(19) United States
(12) Patent Application Publication
(10) Pub. No.: US 2009/0078010 A1
(43) Pub. Date: Mar. 26, 2009

(54) Break-In Resistant Cylinder for Locks

(76) Inventors: Luciano Darchini, Faenza (IT); Fausto Fustini, Imola (IT); Stefano Servadei, Faenza (IT)

Correspondence Address: Modiano & Associati, Via Meravigli, 16, Milan, 20123, IT

(21) Appl. No.: 12/087,057

(22) PCT Filed: Dec. 28, 2006
(86) PCT No.: PCT/EP2006/070239

§ 371 Date: Jun. 25, 2008

(30) Foreign Application Priority Data
Dec. 29, 2005 (IT) BO2005A000801

(51) Int. Cl. E05B 17/00

(52) U.S. Cl. 70/417

(57) ABSTRACT

A break-in resistant cylinder for locks, comprising a stator provided with a substantially cylindrical longitudinal cavity for accommodating a rotor with a longitudinal recess for the insertion of a key. The rotor and the stator comprise a plurality of channels which are substantially aligned and face each other (when the cylinder is in the closed configuration); the channels accommodate respective coding pins, tumbler pins and any elastic elements designed to prevent the rotation of the rotor within the stator if the key is not present in the longitudinal recess. At least one of the tumbler pins comprises a bush and a spike; the stem of the spike has a smaller diameter than the inside diameter of the bush and is longer than the bush. The spike is arranged so that its head is directed toward the bottom of the channel of the stator and rests against the elastic elements and the free end of the stem rests against the lower surface of the coding pin. The lower surface of the bush rests against the collar of the head of the spike proximate to the coupling of the stem.

The present invention relates to a break-in resistant cylinder for locks, particularly suitable to thwart break-in actions which comprise impulsive percussions on at least one portion of said cylinder.

### BACKGROUND OF THE INVENTION

Locks currently exist which comprise a cylinder (in which the opening key is to be inserted) provided with a stator and a rotor which are mutually coupled by means of a plurality of coding pins and tumbler pins which can slide within stator and rotor channels: each stator channel faces, and is aligned with, the respective rotor channel when the cylinder is in the closed configuration (the key is not inserted or is inserted but not rotated with respect to the insertion configuration).

An axially-acting elastic element is provided between the bottom of the stator channel and the lower surface of the tumbler pin and is designed to keep the tumbler pin spaced from such bottom, barring external actions which entail the lowering of the tumbler pin (for example the insertion of the key in the cylinder).

The key, thanks to its contoured (coded) profile, acts on the upper surface of the coding pins, lowering them and placing the shear line which separates the bottom of the coding pin from the apex of the tumbler pin in perfect alignment with the shear line that is present between the rotor and the stator, which are substantially mutually disengaged (when the key is inserted).

The rotor (when the key is inserted, therefore with the coding pins lowered according to the coding) can be turned by turning the head of the key, which protrudes from the cylinder: in this manner it is possible to open the lock.

Highly effective break-in techniques have been devised recently which are based on the possibility that the effractor may acquire uncoded keys of the same type as the one associated with a given cylinder.

A key of this type has to be shaped by providing a succession of grooves whose depth is equal to, or greater than, the maximum depth that is present in the original key (associated with the cylinder of interest) and possibly by removing a small part of material from the portion of the key that abuts against the front of the cylinder.

Once this “generic” key has been provided, the break-in action consists in inserting the key in the cylinder, subjecting it to torque and rhythmically striking its protruding head with a means of substantial mass.

The percussion of the mass on the head of the key entails a small and very fast advancement of the key in the cylinder, with a consequent impulsive impact of the inclined surface of each of the grooves against the head of the respective coding pin of the cylinder: as a consequence of this impact, the coding pin transfers the accumulated energy to the tumbler pin (since they rest against each other), which is propelled toward the bottom of the stator channel, compressing the spring or other elastic means.

If, following a certain number of successive percussions, all the tumbler pins are at the same time each completely within the respective stator channel, at that instant the rotor and the stator are mutually disengaged (the rotor can rotate freely): the torque applied to the head of the key at that moment entails a rotation of the rotor and therefore the opening of the lock.

The described break-in action is substantially applicable to all types of cylinder and is therefore extremely dangerous also in view of the fact that often it does not even leave marks which might indicate that tampering has occurred.

EP-0 452 297 A1 discloses a lock that has means which may prevent the break-in action by percussion on the keyhead.

### SUMMARY OF THE INVENTION

The aim of the present invention is to obviate the above-mentioned drawbacks and meet the mentioned requirements, by providing a break-in resistant cylinder for locks which cannot be opened with the described break-in method.

Within this aim, an object of the present invention is to provide a cylinder which is simple, relatively easy to provide in practice, safe in use, effective in operation, and has a relatively low cost.

This aim and this and other objects that will become better apparent hereinafter are achieved by a break-in resistant cylinder for locks, according to the present invention, that has the features set forth in claim 1.

### BRIEF DESCRIPTION OF THE DRAWINGS

Further characteristics and advantages of the invention will become better apparent from the following detailed description of a preferred but not exclusive embodiment of a break-in resistant cylinder for locks, illustrated by way of non-limiting example in the accompanying drawings, wherein:

FIG. 1 is a sectional front view, taken along a transverse vertical plane, of a first embodiment of a cylinder according to the invention in the inactive configuration;

FIG. 2 is a sectional front view, taken along a transverse vertical plane, of the first embodiment of a cylinder according to the invention with the key, modified for break-in purposes, inserted;

FIG. 3 is a sectional front view, taken along a transverse vertical plane, of the first embodiment of a cylinder according to the invention with the key, modified for break-in purposes, inserted in a position which is partially rotated as a consequence of percussions applied to said key;

FIG. 4 is a sectional side view, taken along a longitudinal vertical plane, of the first embodiment of a cylinder according to the invention with the key, modified for break-in purposes, inserted;

FIG. 5 is a sectional side view, taken along a vertical plane, of a tumbler pin of the first embodiment of a cylinder according to the invention;

FIG. 6 is a sectional side view, taken along a vertical plane, of a bush of the tumbler pin of the first embodiment of a cylinder according to the invention;

FIG. 7 is a sectional side view, taken along a vertical plane, of a spike of the tumbler pin of the first embodiment of a cylinder according to the invention;

FIG. 8 is a sectional front view, taken along a transverse vertical plane, of a second embodiment of a cylinder according to the invention in the inactive configuration;

FIG. 9 is a sectional front view, taken along a transverse vertical plane, of the second embodiment of a cylinder according to the invention with the key, modified for break-in purposes, inserted;

FIG. 10 is a sectional front view, taken along a transverse vertical plane, of the second embodiment of a cylinder according to the invention with the key, modified for break-in purposes, inserted in a position which is partially rotated as a consequence of percussions applied to said key;

FIG. 11 is a sectional side view, taken along a longitudinal vertical plane, of the second embodiment of a cylinder according to the invention with the key, modified for break-in purposes, inserted;

FIG. 12 is a sectional side view, taken along a vertical plane, of a tumbler pin of the second embodiment of a cylinder according to the invention;

FIG. 13 is a sectional side view, taken along a vertical plane, of a bush of the tumbler pin of the second embodiment of a cylinder according to the invention;

FIG. 14 is a sectional side view, taken along a vertical plane, of a spike of the tumbler pin of the second embodiment of a cylinder according to the invention;

FIG. 15 is a sectional front view, taken along a transverse vertical plane, of a third embodiment of a cylinder according to the invention in the inactive configuration;

FIG. 16 is a sectional front view, taken along a transverse vertical plane, of the third embodiment of a cylinder according to the invention with the key, modified for break-in purposes, inserted;

FIG. 17 is a sectional front view, taken along a transverse vertical plane, of the third embodiment of a cylinder according to the invention with the key, modified for break-in purposes, inserted, in a position which is partially rotated as a consequence of percussions applied to such key;

FIG. 18 is a sectional side view, taken along a longitudinal vertical plane, of a third embodiment of a cylinder according to the invention with the key, modified for break-in purposes, inserted;

FIG. 19 is a sectional side view, taken along a vertical plane, of a tumbler pin of the third embodiment of a cylinder according to the invention;

FIG. 20 is a sectional side view, taken along a vertical plane, of a bush of the tumbler pin of the third embodiment of a cylinder according to the invention;

FIG. 21 is a sectional side view, taken along a vertical plane, of a spike of the tumbler pin of the third embodiment of a cylinder according to the invention;

FIG. 22 is a sectional front view, taken along a transverse vertical plane, of a fourth embodiment of a cylinder according to the invention in the inactive configuration;

FIG. 23 is a sectional front view, taken along a transverse vertical plane, of the fourth embodiment of a cylinder according to the invention, with the key, modified for break-in purposes, inserted;

FIG. 24 is a sectional front view, taken along a transverse vertical plane, of the fourth embodiment of a cylinder according to the invention with the key, modified for break-in purposes, inserted, in a position which is partially rotated as a consequence of percussions applied to such key;

FIG. 25 is a sectional side view, taken along a longitudinal vertical plane, of the fourth embodiment of a cylinder according to the invention with the key, modified for break-in purposes, inserted;

FIG. 26 is a sectional side view, taken along a vertical plane, of a tumbler pin of the fourth embodiment of a cylinder according to the invention;

FIG. 27 is a sectional side view, taken along a vertical plane, of a bush of the tumbler pin of the fourth embodiment of a cylinder according to the invention;

FIG. 28 is a sectional side view, taken along a vertical plane, of a spike of the tumbler pin of the fourth embodiment of a cylinder according to the invention;

FIG. 29 is a sectional front view, taken along a transverse vertical plane, of a fifth embodiment of a cylinder according to the invention in the inactive configuration;

FIG. 30 is a sectional front view, taken along a transverse vertical plane, of the fifth embodiment of a cylinder according to the invention with the key, modified for break-in purposes, inserted;

FIG. 31 is a sectional front view, taken along a transverse vertical plane, of the fifth embodiment of a cylinder according to the invention with the key, modified for break-in purposes, inserted in a position which is partially rotated as a consequence of percussions applied to said key;

FIG. 32 is a sectional side view, taken along a longitudinal vertical plane, of the fifth embodiment of a cylinder according to the invention with the key, modified for break-in purposes, inserted;

FIG. 33 is a sectional side view, taken along a vertical plane, of a tumbler pin of the fifth embodiment of a cylinder according to the invention;

FIG. 34 is a sectional side view, taken along a vertical plane, of a bush of the tumbler pin of a fifth embodiment of a cylinder according to the invention;

FIG. 35 is a sectional side view, taken along a vertical plane, of a spike of the tumbler pin of a fifth embodiment of a cylinder according to the invention;

FIG. 36 is a sectional side view, taken along a vertical plane, of a coding pin of the fifth embodiment of a cylinder according to the invention;

FIG. 37 is a sectional front view, taken along a transverse vertical plane, of a sixth embodiment of a cylinder according to the invention in the inactive configuration;

FIG. 38 is a sectional front view, taken along a transverse vertical plane, of the sixth embodiment of a cylinder according to the invention with the key, modified for break-in purposes, inserted;

FIG. 39 is a sectional front view, taken along a transverse vertical plane, of the sixth embodiment of a cylinder according to the invention with the key, modified for break-in purposes, inserted, in a position which is partially rotated as a consequence of percussions applied to said key;

FIG. 40 is a sectional side view, taken along a longitudinal vertical plane, of the sixth embodiment of a cylinder according to the invention with the key, modified for break-in purposes, inserted;

FIG. 41 is a sectional side view, taken along a vertical plane, of a tumbler pin of the sixth embodiment of a cylinder according to the invention;

FIG. 42 is a sectional side view, taken along a vertical plane, of a bush of a tumbler pin of the sixth embodiment of a cylinder according to the invention;

FIG. 43 is a sectional side view, taken along a vertical plane, of a spike of the tumbler pin of the sixth embodiment of a cylinder according to the invention;

FIG. 44 is a sectional side view, taken along a vertical plane, of a portion of the rotor of the sixth embodiment of a cylinder according to the invention.

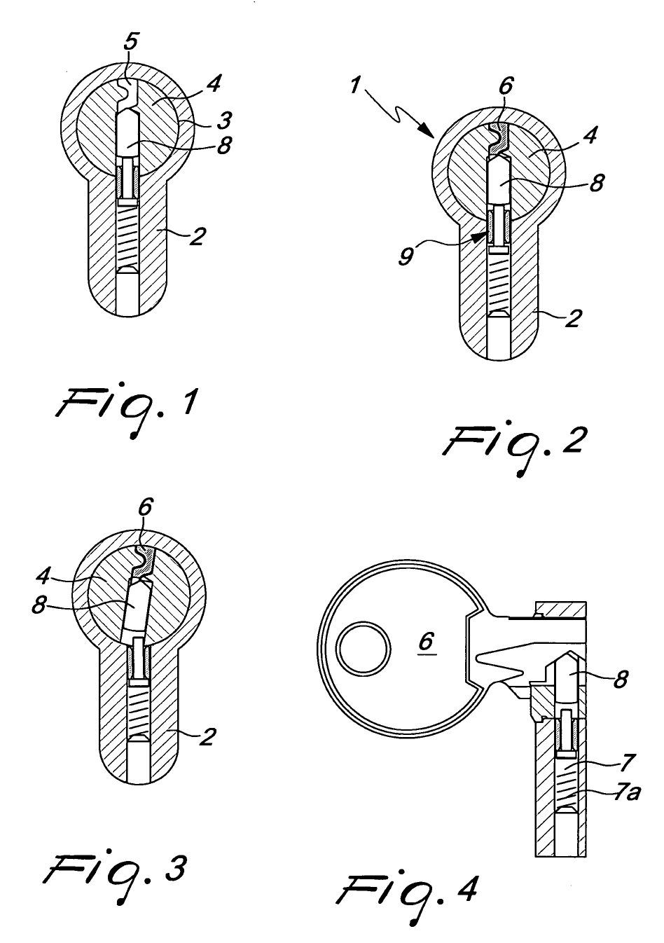

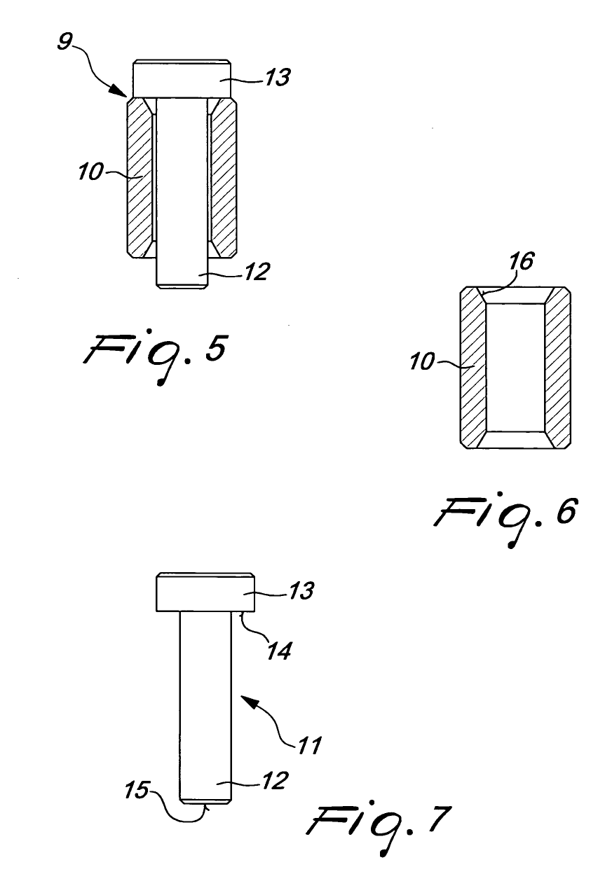

### DESCRIPTION OF THE PREFERRED EMBODIMENTS

With reference to the figures, the reference numeral 1 generally designates a break-in resistant cylinder for locks.

For the purposes of the description of the preferred embodiments of the invention terms are used, such as “bottom”, “lower”, “upper”, “lateral”, that all refer, as the person skilled in the art would unambiguously understand, to the normal use position of the various parts of the lock as this is shown in the accompanying figures.

The cylinder 1 comprises a stator 2 which is provided with a substantially cylindrical longitudinal cavity 3 for accommodating a rotor 4 with a longitudinal recess 5 for the insertion of a key 6: the key 6 is the one designed to open the cylinder 1.

The rotor 4 and the stator 2 comprise a plurality of channels 7: the portion of channel 7 comprised within the stator 2 and the portion comprised within the rotor 4 are substantially aligned and face each other when the cylinder 1 is in the closed configuration.

The channels 7 are designed to accommodate respective coding pins 8, tumbler pins 9 and optional elastic means 7a which are intended to prevent the rotation of the rotor 4 within the stator 2 if the key 6 is not present in the longitudinal recess 5.

At least one of the tumbler pins 9 comprises a bush 10 and a spike 11. In particular, the spike 11 is provided with a stem 12 whose diameter is slightly smaller than the inside diameter of the bush 10 and which is longer than the bush 10. In practice, when the spike 11 has its stem 12 inserted within the bush 10 and the head 13 of the spike 11 has its collar 14 rested against one of the end surfaces of the bush 10, the end 15 of the stem 12 protrudes from the bush 10 and is in contact with the lower surface of the coding pin 8. In the assembly configuration, inside the cylinder 1 the head 13 of the spike 11 rests against the upper end of the elastic means 7a and is directed toward the bottom of the portion of the channel 7 of the stator 2. In particular, it can be noted that the stem 12 is substantially cylindrical and is slender and rigidly coupled at one of its ends to the head 13, which is circular, and has a diameter which is smaller than the diameter of the containment channels 7 and greater than the inside diameter of the bush 10.

The bush 10 has, at least one of the end inlets leading to its internal channel, frustum-shaped flared portions 16.

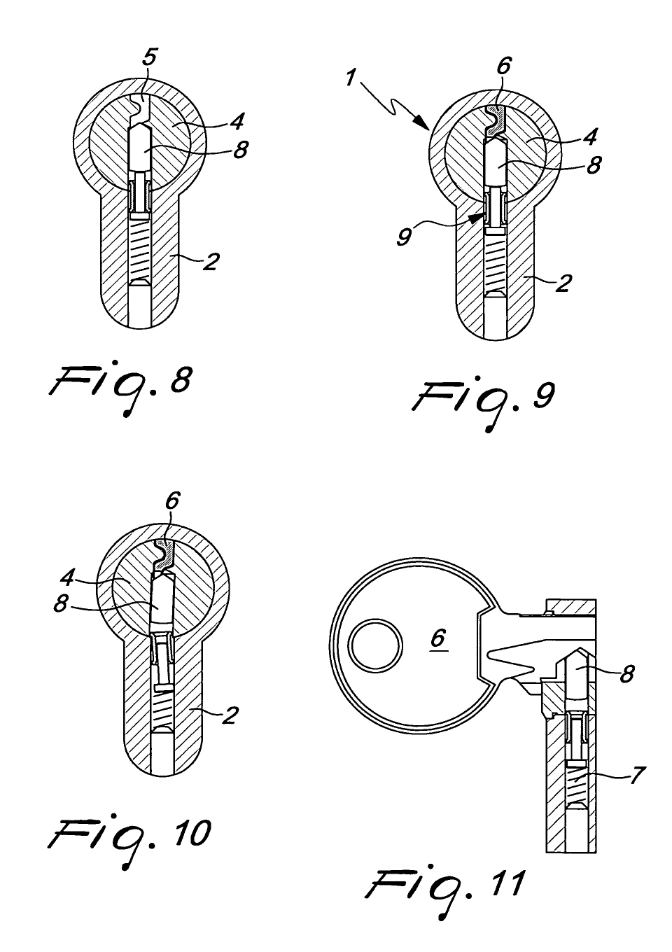

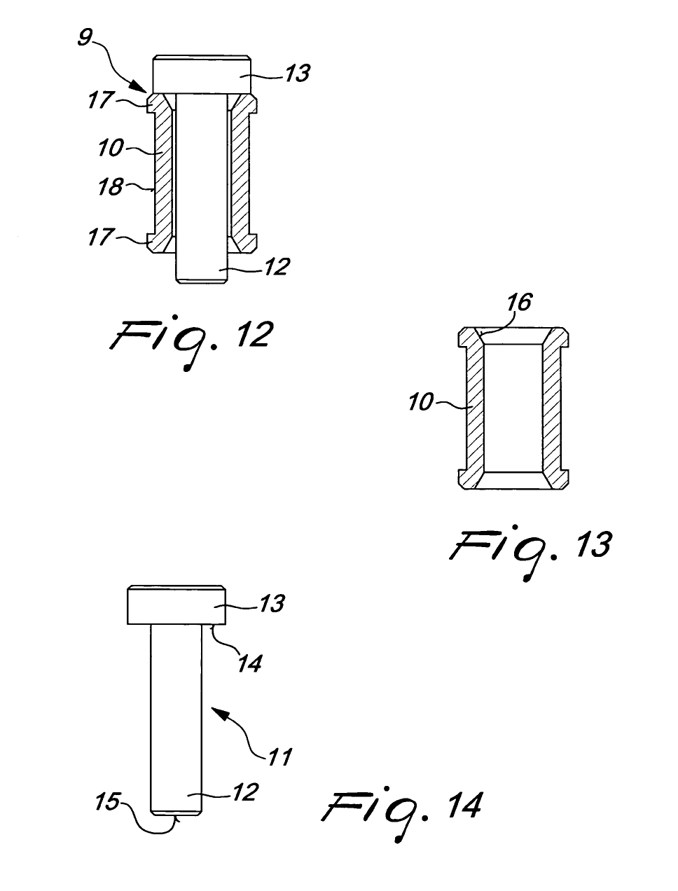

According to a second embodiment described in FIGS. 8 to 14 (but in any case applicable also to all the other possible embodiments), the bush 10 has end rims 17 whose diameter is close to the diameter of the channels 7 of the stator 2 and of the rotor 4 and a portion 18 which has a smaller diameter and is comprised between the rims 17.

The purpose of such a shape becomes particularly evident by analyzing FIG. 10: the reduction in diameter that corresponds to the portion 18 facilitates the non-axial movements of the bush 10, consequently easily trapping the bush 10 in the shear line that is present between the channels 7 of the stator 2 and of the rotor 4.

In the case of a break-in action with percussions on the key 6, the movements of the bush 10 in an axial direction within the channels 7 are hindered not only by friction against the walls of the channel 7 but also by the fact that the attempt to turn the rotor 4 (by means of a torque applied constantly to the key 6 during percussions) facilitates the trapping of the bush 10 as a consequence of the locking of one of the rims 17 beyond the shear line that is present between the channels 7 of the stator 2 and the rotor 4.

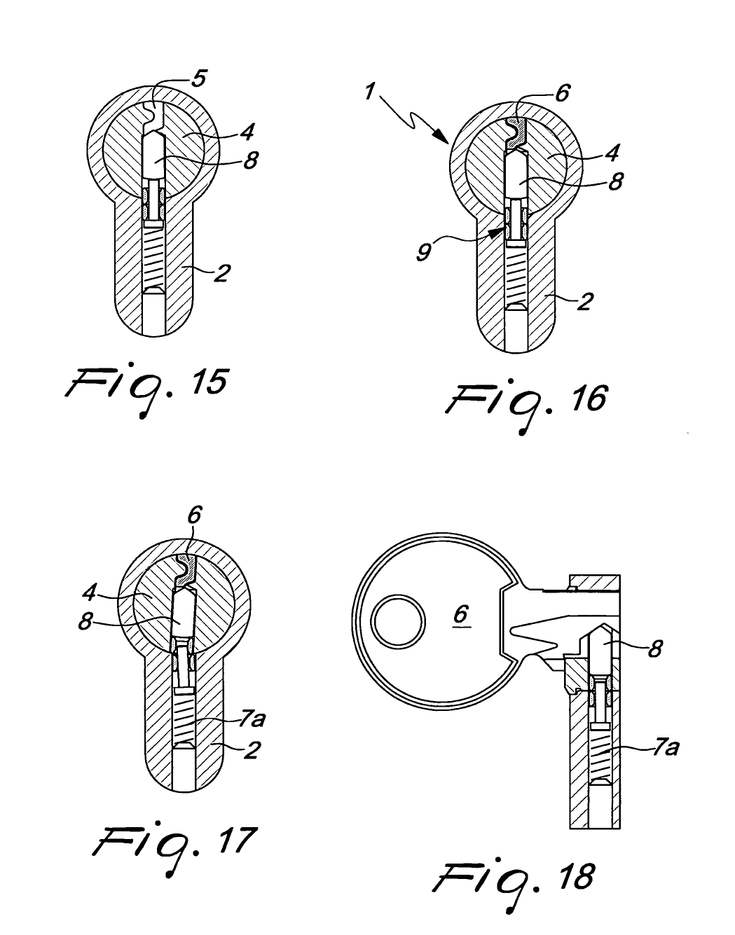

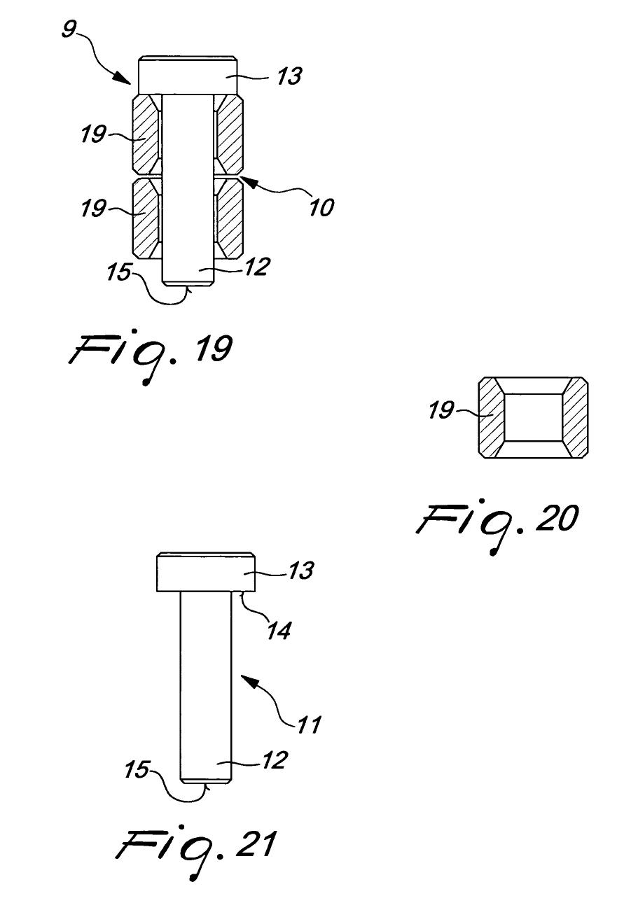

According to a third embodiment described in FIGS. 15 to 21 (but in any case applicable also to all the other possible embodiments), the bush 10 is constituted by at least two aligned tubular bodies 19.

The purpose of such a configuration becomes particularly evident by analyzing FIG. 17: the discontinuity provided between the two tubular bodies 19 facilitates the non-axial movements of the bush 10 (axial offset of one tubular body 19 with respect to the other), with consequent easily trapping of the stem 12 in the shear line provided between the channels 7 of the stator 2 and the rotor 4.

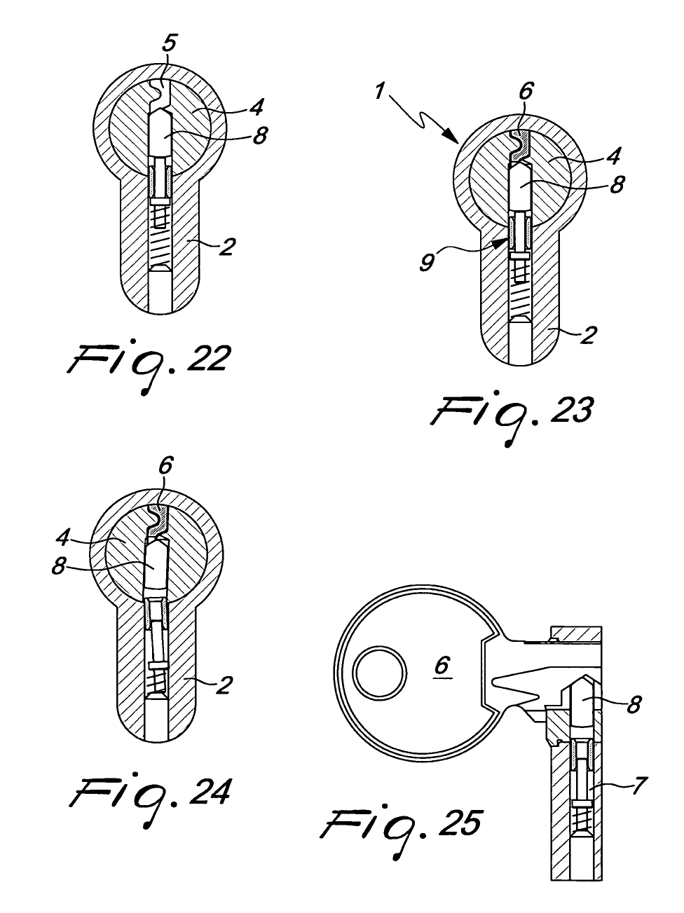

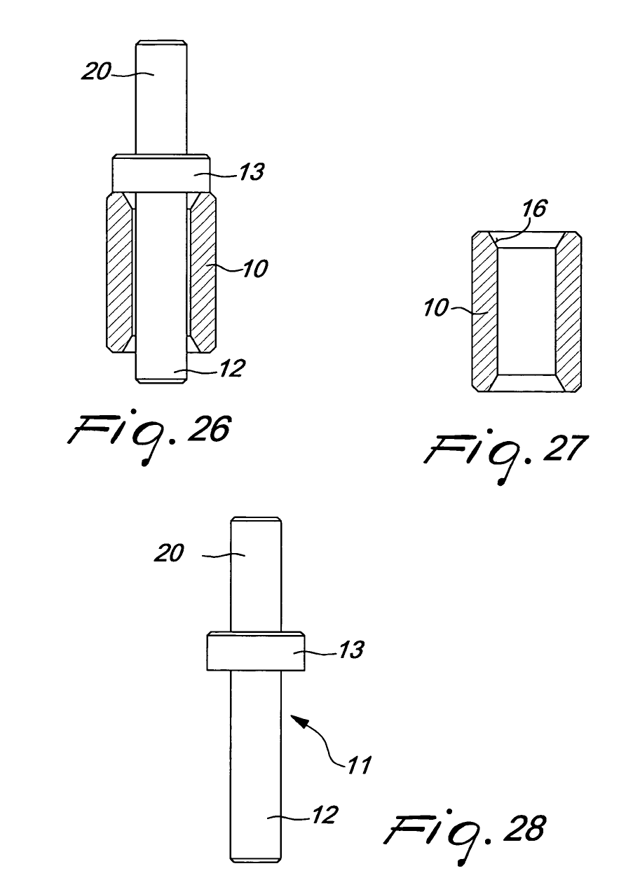

According to a fourth embodiment described in FIGS. 22 to 28 (but in any case applicable also to all other possible embodiments), a slender shank 20 protrudes from the head 13 of the spike 11 toward the bottom of the portion of the channel 7 of the stator 2 and is substantially shorter than the stem 12.

The purpose of such a configuration becomes particularly evident by analyzing FIG. 24: even if the percussion is particularly forceful (therefore capable of moving the head 13 considerably away from the end surface of the bush 10), there is no risk of the stem 12 escaping from the bush 10, since the shank 20 reaches the bottom of the portion of the channel 7 of the stator 2 while the end 20 is still within the bush 10.

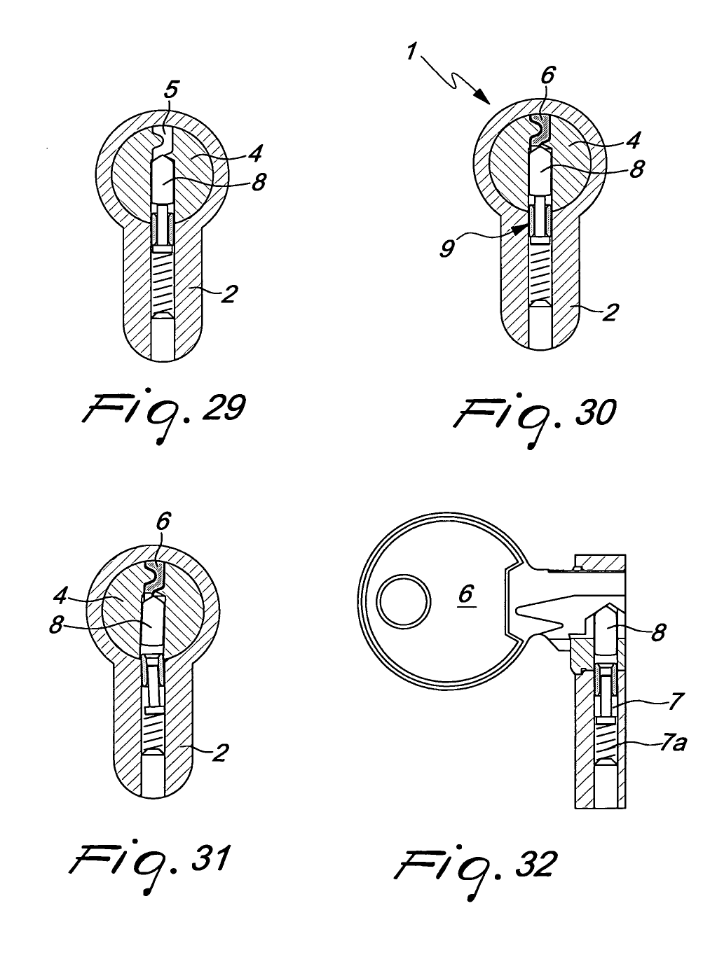

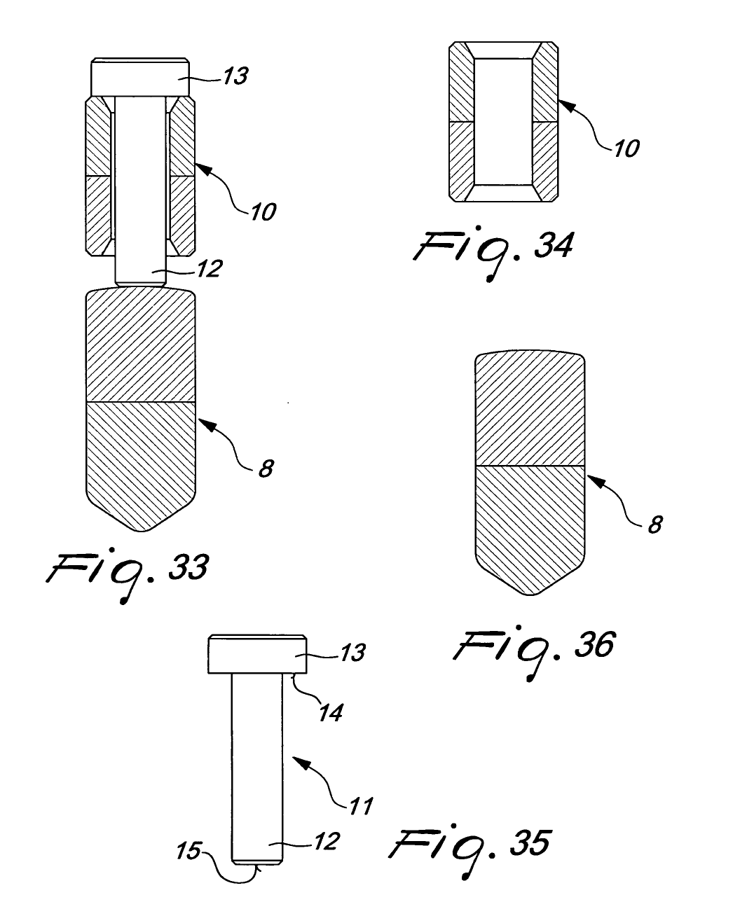

According to a fifth embodiment described in FIGS. 29 to 36 (but in any case applicable also to all other possible embodiments), the coding pin 8 and the bush 10 are magnets: in particular, the lower portion of the coding pin 8 and the upper portion of the bush 10, which face each other, have the same polarity (both magnetic north or south poles) in order to establish a magnetic mutual repulsive force which ensures (even in particularly demanding installation conditions) that the bush 10 never rests against the coding pin 8. The purpose of such a configuration is to ensure that the transfer of energy as a consequence of percussion occurs only between the coding pin 8 and the spike 11, without involving the bush 10, which remains stationary in a position for mutually coupling the stator 2 and the rotor 4.

The tumbler pins 9, which are shaped according to one of the possible embodiments (optionally one of the ones described or a combination of one or more of them), i.e., comprise the bush 10 and the spike 11, are at least two and are arranged with respect to each other in any configuration also with respect to the other traditional tumbler pins provided in the cylinder 1: in practice, the cylinder 1 can comprise any number of coding pins 8 and tumbler pins associated therewith, and among these there can be one, two or more tumbler pins 9 (according to the teaching of the present application) which are arranged in any configuration with respect to each other.

One embodiment which is particularly secure against a break-in action which comprises percussions on the key for the cylinder 1 according to the invention is the one which comprises exclusively tumbler pins 9 which comprise a bush 10 and a spike 11: in this manner, the cylinder 1 has the maximum level of security against this type of break-in.

The principle on which the operation of such a cylinder 1 is based is the principle of so-called “Newton's cradle”: a plurality of steel balls hang from an upper frame in substantial mutual alignment. The movement of one of the end balls entails its impact, during oscillation, against the surface of the adjacent ball. The balls that lie next to the adjacent ball remain stationary, while the last ball of the row is propelled outward so as to oscillate. At this point, motion continues in a substantially symmetrical and damped manner.

The percussion of the key 6 on the coding pin 8, which rests against the end 15 of the stem 12 of the spike 11, entails the transfer of energy (and therefore of motion) to the spike 11, which is propelled downward, while the other components remain stationary.

Since the bush 10 is not in contact with the coding pin 8 (and is further subjected to friction between its lateral surfaces and the internal surface of the channels 7), it does not undergo translational motions of a consequence of percussion and ensures that it is impossible for the rotor 4 to rotate with respect to the stator 2.

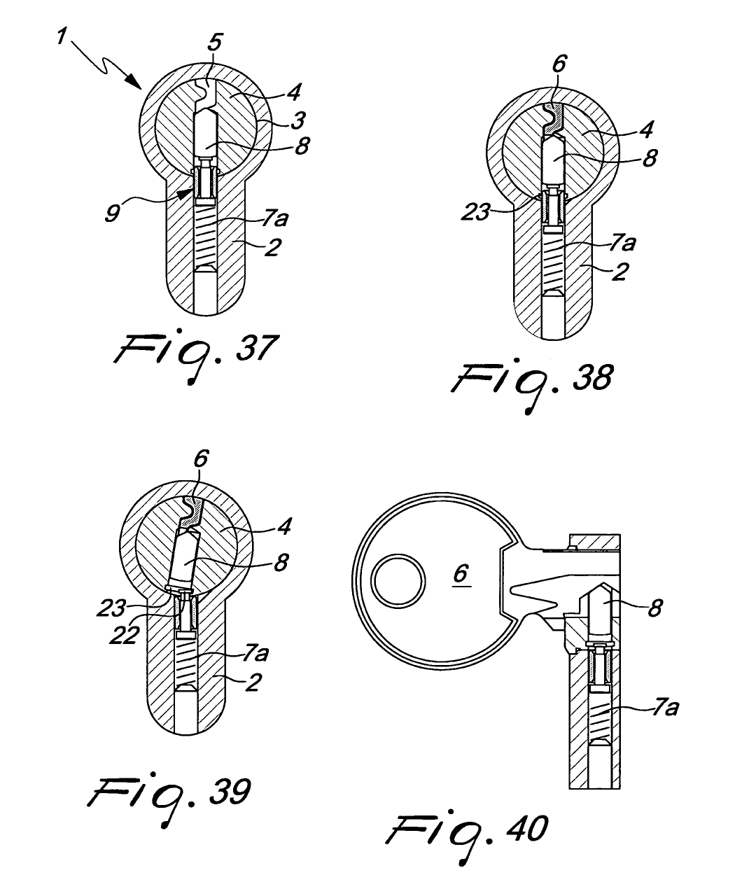

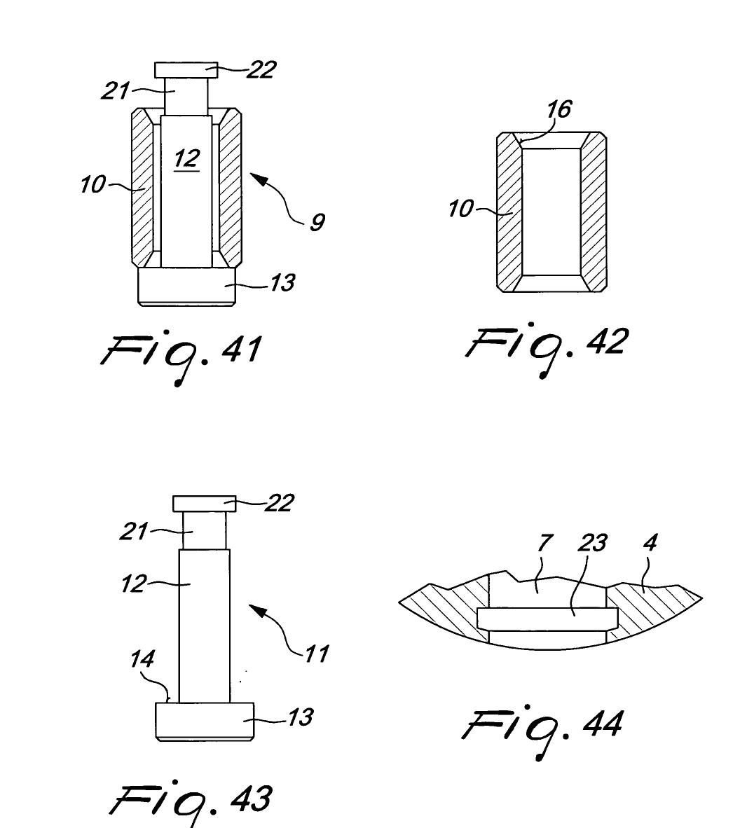

FIGS. 37 to 44 show that it is possible to shape the stem 11, particularly its portion 12 which protrudes from the bush 10, with an annular groove 21 which is surmounted by an end disk 22; in this case, in the channel 7 of the rotor 4, proximate to the shear line with the stator 2, there must be a torus-like channel 23.

The channel 23 traps the disk 22 during break-in attempts, ensuring optimum behavior of the cylinder 1.

This solution finds a particular application in cases in which the cylinder 1 is assembled upside down, since the trapping action eliminates the negative effect produced by the force of gravity which keeps the bush 9 proximate to the coding pin 8.

The embodiments which provide for additional components and/or modified components merely have the purpose of enhancing the described phenomenon, ensuring that the bush 10 remains stationary.

It has thus been shown that the invention achieves the intended aim and object.

The invention thus conceived is susceptible of numerous modifications and variations, all of which are within the scope of the appended claims.

All the details may further be replaced with other technically equivalent ones.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the shapes and dimensions, may be any according to requirements without thereby abandoning the scope of the protection of the appended claims.

The disclosures in Italian Patent Application No. B02005A000801 from which this application claims priority are incorporated herein by reference.

What is claimed is:

1-8. (canceled)

9. A break-in resistant cylinder for locks, of the type which comprises, in a normal use position, a stator provided with a substantially cylindrical longitudinal cavity for accommodating a rotor with a longitudinal recess for the insertion of a key, said rotor and said stator comprising a plurality of channels which are substantially aligned and face each other when the cylinder is in the closed configuration, said channels for accommodating respective coding pins, tumbler pins and any elastic means designed to prevent the rotation of the rotor within the stator if the key is not present in said longitudinal recess, wherein at least one of said tumbler pins comprises a bush and a spike, a stem of said spike having a smaller diameter than an inside diameter of said bush and being longer than said bush, said spike being arranged so that its head is directed toward a bottom of said channel of the stator and rests against said elastic means and a free end of the stem rests against a lower surface of the coding pin, a lower surface of said bush resting against a collar of said head of the spike proximate to a coupling of the stem, wherein a slender shank protrudes from the head of said spike toward the bottom of the channel of the stator and is substantially shorter than the stem.

10. The cylinder of claim 9, wherein said bush has, at the end inlets leading to its internal channel, frustum-shaped flared portions.

11. The cylinder of claim 9, wherein said bush is provided with end rims whose diameter is proximate to the diameter of said channels of the stator and rotor and a portion having a smaller diameter which is comprised between said rims.

12. The cylinder of claim 9, wherein said stem is a slender substantially cylindrical stem, which is provided at an end with a disk-shaped head, whose diameter is smaller than a diameter of the channels and greater than the inside diameter of said bush.

13. The cylinder of claim 9, wherein said bush is constituted by at least two aligned tubular bodies.

14. The cylinder of claim 9, wherein said coding pin and said bush are magnets, a lower portion of said coding pin and an upper portion of said bush, which face each other, having a same polarity so as to establish a mutually repulsive magnetic force.

15. The cylinder of claim 9, wherein said tumbler pins which comprise a bush and a spike are at least two and are mutually arranged in any configuration also with respect to other traditional tumbler pins provided in the cylinder.

16. The cylinder of claim 9, comprising only tumbler pins which comprise a bush and a spike.
